(19) United States
(12) Patent Application Publication
(10) Pub. No.: US 2005/0263316 A1
(43) Pub. Date: Dec. 1, 2005

(54) Anti-crosstalk cabling method, anti-crosstalk member and anti-crosstalk device for telecommunication cable

(76) Inventor: Toshio Matsumoto, Kanagawa (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/139,214

(22) Filed: May 27, 2005

Related U.S. Application Data
(60) Provisional application No. 60/575,710, filed on May 28, 2004.

(51) Int. Cl. H01B 11/02

(52) U.S. Cl. 174/113 R

(57) ABSTRACT

Anti-crosstalk members for telecommunication cable are constructed by plastic blocks. The blocks are formed in cylindrical shape and provided with a plurality of cable fit-in slots in a circumferential direction on an outer peripheral surface thereof. The anti-crosstalk members are arranged properly spaced apart with one another and mounted to the telecommunication cables respectively. The anti-crosstalk members are mounted to the telecommunication cables by fitting each of the telecommunication cables in respective cable fit-in slot such that the telecommunication cables are arranged in non-parallel fashion among the anti-crosstalk members.

### BACKGROUND OF THE INVENTION

The present invention relates to an anti-crosstalk cabling method for telecommunication cable to prevent or suppress crosstalk from being generated between the telecommunication cables, to be adapted for computer network or the like where a plurality of telecommunication cables are arranged in a bundle, an anti-crosstalk member for telecommunication cable and anti-crosstalk device for telecommunication cable to be applied in the anti-crosstalk cabling method for telecommunication cable.

With increase in the data transmission speed in computer network, crosstalk has been generated in telecommunication cable. Such crosstalk can be effectively prevented or suppressed by adapting such proper measures that a cable having insulating layer such as coaxial cable is applied for telecommunication cable or wires are twisted together at different pitch respectively in a telecommunication cable.

However, if data transmission speed is made remarkably faster in computer network, there might be generated crosstalk (alien crosstalk) between the telecommunication cables. In case that crosstalk is generated between the telecommunication cables, communication failure is predicted such as slow-down of data transmission speed or interruption of data transmission. It is confirmed that such crosstalk between the telecommunication cables is generated when a plurality of the telecommunication cables are laid out in close proximity-parallel, or contact-parallel relation to one another, for example, as long as 10 m. So, it becomes essential to arrange the telecommunication cables neither in close proximity-parallel nor contact-parallel relation to one another for a long distance. However, if the number of computers used in an office or the like, is increased, the number of telecommunication cables is increased accordingly, and, in many cases, a plurality of the telecommunication cables must be bundled together and laid out. And, when a plurality of telecommunication cables are laid out in a bundle, all individual ones run in close proximity-parallel or contact-parallel relation to one another for a long distance, or adjacent ones are in close proximity-parallel, or contact-parallel relation to one another for a long distance.

Under the circumstances described above, it is an object of the present invention to provide an anti-crosstalk cabling method for telecommunication cable in order to prevent crosstalk from being generated between a plurality of telecommunication cables laid out in a bundle. And, it is also an object of the present invention to provide an anti-crosstalk member and an anti-crosstalk device for telecommunication cable to be adapted in the anti-crosstalk cabling method for telecommunication cable in order to prevent crosstalk from being generated between the plurality of the telecommunication cables laid out in a bundle.

### SUMMARY OF THE INVENTION

An anti-crosstalk cabling method for telecommunication cable according to the present invention in order to achieve the foregoing object, prevents crosstalk generated between a plurality of telecommunication cables laid out in a bundle or bundles of the telecommunication cables. The anti-crosstalk cabling method comprises locating each of the telecommunication cables on two or more positioning spots along an extending direction of the telecommunication cables such that at least a relative locational relationship is maintained in the telecommunication cables on the positioning spots, and laying out the telecommunication cables so as to be located in different sequential arrangement on one or each positioning spot and a positioning spot neighboring to the one positioning spot. Depending on circumstances, the positioning spots may be set on a floor or the like, or suitable parts of the telecommunication cables. A mode of a sequential arrangement of the telecommunication cables is properly varied on one and neighboring positioning spots to prevent effectively that the telecommunication cables run long in close proximity-parallel or contact-parallel relation to one another. As for one applicable mode of varied sequential arrangement of the telecommunication cables, the telecommunication cables are laid out such that any or each pair of adjacent telecommunication cables on one positioning spot are different in a sequential arrangement from any or each pair of adjacent telecommunication cables on a positioning spot neighboring to the one positioning spot. When telecommunication cables are laid out in this manner, it is effectively prevented that two telecommunication cables are laid out in adjacent parallel relation to one another between set positioning spots. More preferably, additionally, the telecommunication cables are laid out such that any or each pair of adjacent but one telecommunication cables on the one positioning spot are different in a sequential arrangement from any or each pair of adjacent but one telecommunication cables on the positioning spot neighboring to the one positioning spot. Or, the telecommunication cables are laid out such that any or each pair of adjacent telecommunication cables on one positioning spot are different in combination from any or each pair of adjacent telecommunication cables on a positioning spot neighboring to the one positioning spot. Moreover, as for one applicable mode of varied arrangement of the telecommunication cables, the telecommunication cables are arranged such that any pair of the telecommunication cables run in non-parallel relation to one another (non-parallel fashion) between one positioning spot and a positioning spot neighboring to the one positioning spot.

Also, an anti-crosstalk member for telecommunication cable according to the present invention is adapted in the anti-crosstalk cabling method for telecommunication cable in order to prevent crosstalk generated between a plurality of telecommunication cables laid out in a bundle which comprises locating each of the telecommunication cables on two or more positioning spots along an extending direction of the telecommunication cables such that at least a relative locational relationship is maintained in the telecommunication cables on the positioning spots, and laying out the telecommunication cables so as to be located in different sequential arrangement on one positioning spot and a positioning spot neighboring to the one positioning spot. The anti-crosstalk member for telecommunication cable is arranged on each of the positioning spots and comprises a block provided with a plurality of cable fit-in slots, and the telecommunication cables are fitted in the cable fit-in slots respectively such that at least a relative locational relationship is maintained in the telecommunication cables. Depending on circumstances, the anti-crosstalk member may be fixed on a floor or the like. Or, the anti-crosstalk member may be fixed only to the telecommunication cables, without being fixed on a floor or the like. The block may be formed in cylindrical or disk shape and provided with a plurality of the cable fit-in slots circumferentially spaced apart on an outer peripheral surface thereof Such block is preferably formed to have a relatively short length and so small diameter, for example, as to allow the telecommunication cables to be laid out in bundled state or bundled fashion. And, in order to avoid the telecommunication cables from coming off the cable fit-in slots, it is advantageous in this case to use removable fastener tape which wraps around the telecommunication cables fitted in the cable fit-in slots respectively to fasten the telecommunication cables to the block.

The block may have or be provided with a rectangularly corrugated cross-section and is provided with a plurality of the cable fit-in slots spaced apart in a widthwise direction thereof Thus configured block is suitable for a cabling mode wherein the bundles of the telecommunication cables are laid out so as to be split up in a direction perpendicular to length of the telecommunication cables.

Furthermore, an anti-crosstalk device for telecommunication cable according to the present invention is adapted in the anti-crosstalk cabling method for telecommunication cable in order to prevent crosstalk generated between a plurality of telecommunication cables laid out in a bundle which comprises locating each of the telecommunication cables on two or more positioning spots along an extending direction of the telecommunication cables such that at least a relative locational relationship is maintained in the telecommunication cables on the positioning spots, and laying out the telecommunication cables so as to be located in different sequential arrangement on one positioning spot and a positioning spot neighboring to the one positioning spot. The anti-crosstalk device for telecommunication cable comprises all of anti-crosstalk members for telecommunication cable to be arranged on the positioning spots respectively. Each of the anti-crosstalk members has a block provided with a plurality of cable fit-in slots wherein the telecommunication cables are fitted respectively such that at least a relative locational relationship is maintained in the telecommunication cables. The block includes varied cable distinguishing indications which are given respectively for the cable fit-in slots. The cable distinguishing indications on the one anti-crosstalk member are different in a sequential arrangement from those on the anti-crosstalk member to be arranged neighboring to the one anti-crosstalk member. The telecommunication cables are fitted respectively in the cable fit-in slots with identical cable distinguishing indications on each of the anti-crosstalk members for telecommunication cable. To each of the blocks, for example, identical series or identical combination of the cable distinguishing indications are applied. The sequential arrangement of the cable distinguishing indications means, for example, a sequential arrangement in a side by side direction of a plurality of the cable fit-in slots. When the block is formed in cylindrical or disk shape and provided with a plurality of the cable fit-in slots spaced apart from one another in a circumferential direction on an outer peripheral surface thereof, the sequential arrangement of the cable distinguishing indications means, for example, the sequential arrangement of the cable distinguishing indications in a circumferential direction of the block. On the other hand, when the block has a rectangularly corrugated cross-section and is provided with a plurality of the cable fit-in slots spaced apart from one another in a widthwise direction, the sequential arrangement of the cable distinguishing indications means, for example, the sequential arrangement of the cable distinguishing indications in a widthwise direction of the block. In such manner, such cabling structure is easily constructed as not to allow the telecommunication cables to run in close proximity-parallel or contact-parallel relation to one another for a long distance. As one mode of varied sequential arrangement of the cable distinguishing indications, applicable is such manner that any or each pair of adjacent cable distinguishing indications on one anti-crosstalk member are different in a sequential arrangement from any or each pair of adjacent cable distinguishing indications on an anti-crosstalk member to be arranged neighboring to the one anti-crosstalk member. More preferably, additionally, any or each pair of adjacent but one cable distinguishing indications on one anti-crosstalk member are different in a sequential arrangement from any or each pair of adjacent but one cable distinguishing indications on an anti-crosstalk member to be arranged neighboring to the one anti-crosstalk member. Or, the cable distinguishing indications are arranged such that any or each pair of adjacent cable distinguishing indications on one anti-crosstalk member are different in combination from any or each pair of adjacent cable distinguishing indications on an anti-crosstalk member to be arranged neighboring to the one anti-crosstalk member. The combination of the cable distinguishing indications means, for example, combination in a side by side direction of a plurality of the cable fit-in slots. When the block is formed in cylindrical or disk shape and provided with a plurality of the cable fit-in slots spaced apart from one another in a circumferential direction on an outer peripheral surface thereof, the combination of the cable distinguishing indications means, for example, the combination of the cable distinguishing indications in a circumferential direction of the block. On the other hand, when the block has a rectangularly corrugated cross-section and is provided with a plurality of the cable fit-in slots spaced apart from one another in a widthwise direction, the combination of the cable distinguishing indications means, for example, the combination of the cable distinguishing indications in a widthwise direction of the block.

Each of the telecommunication cables may have a varied cable identifying marking corresponding to each of the cable distinguishing indications, and the telecommunication cables may be fitted respectively in the cable fit-in slot with identical cable distinguishing indication on each of the anti-crosstalk members so as to match the cable identifying marking of the telecommunication cable and the cable distinguishing indication of the cable fit-in slot. This facilitates easy lay-out of the telecommunication cables. More preferably, the cable distinguishing indications of the cable fit-in slots are shown by color coding and the cable identifying markings of the telecommunication cables are shown also by color coding which is represented by color of cable sheath. As the case may be, color coding of the cable fit-in slots may be represented by color of the block itself.

As described above, in the anti-crosstalk cabling method for telecommunication cable of the present invention, a plurality of the telecommunication cables are laid out in the non-parallel fashion. Therefore, it is effectively prevented that the telecommunication cables are laid out in close proximity-parallel relation or contact-parallel relation to one another. And, the anti-crosstalk member for telecommunication cable and the anti-crosstalk device for telecommunication cable according to the present invention allow to lay out the telecommunication cables in the non-parallel fashion easily and quickly.

Now, the preferred embodiments of the present invention will be described in detail with reference to the drawings.

### BRIEF DESCRIPTION OF THE DRAWINGS

FIG. 1 is a schematic view of a communication network structure in case that a plurality of computer terminals are disposed in a room of a construction such as building.

FIG. 2 is a perspective view showing anti-crosstalk device for telecommunication cable according to the present invention.

FIG. 3 is a front view showing blocks adapted for the anti-crosstalk device.

FIG. 4 is a perspective view in order to explain attaching the anti-crosstalk device to telecommunication cables.

FIG. 5 is a schematic perspective view showing a state that anti-crosstalk cabling method for telecommunication cable according to the present invention is implemented by attaching the anti-crosstalk device to the telecommunication cables.

FIG. 6 is a perspective view showing another anti-crosstalk device for telecommunication cable having another configuration according to the present invention.

FIG. 7 is a schematic perspective view showing a state that another anti-crosstalk cabling method for telecommunication cable according to the present invention is implemented by attaching the another anti-crosstalk device to the telecommunication cables.

FIG. 8 is a perspective view showing an anti-crosstalk base member to be folded down into three to construct another anti-crosstalk device according to the present invention.

### DETAILED DESCRIPTIONS OF PREFERRED EMBODIMENTS

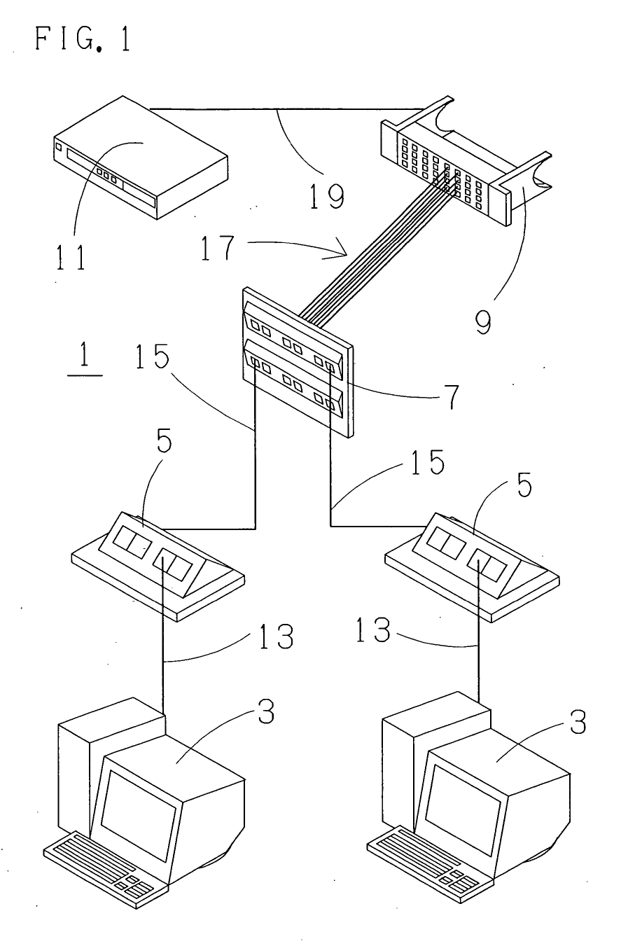

As shown in FIG. 1, a communication network structure 1 comprises a plurality of computer terminals 3 which are disposed in a room of a construction, outlets 5 which are disposed for respective computer terminals 3 in the room, one unit of consolidation point 7 which is disposed for the room of the construction, one unit of patch panel 9 which is disposed for a floor for the room, and one unit of switching hub 11 which is disposed in the construction. The computer terminal 3 connects to the outlet 5 via telecommunication cable 13, the outlets 5 connect to the consolidation point 7 via telecommunication cables 15 respectively. And, the consolidation point 7 connects to the patch panel 9 via a plurality of telecommunication cables 17, and then the patch panel 9 connects to the switching hub 11 via a telecommunication cable 19. The communication cables 17 are bundled together or bunched up and laid out between the consolidation point 7 and the patch panel 9 in close proximity relation with one another.

An anti-crosstalk device 21 for telecommunication cable is adapted for a bundle or a bunch of the telecommunication cables 17 laid out between the consolidation point 7 and the patch panel 9 to prevent crosstalk between telecommunication cables 17 in a bundle.

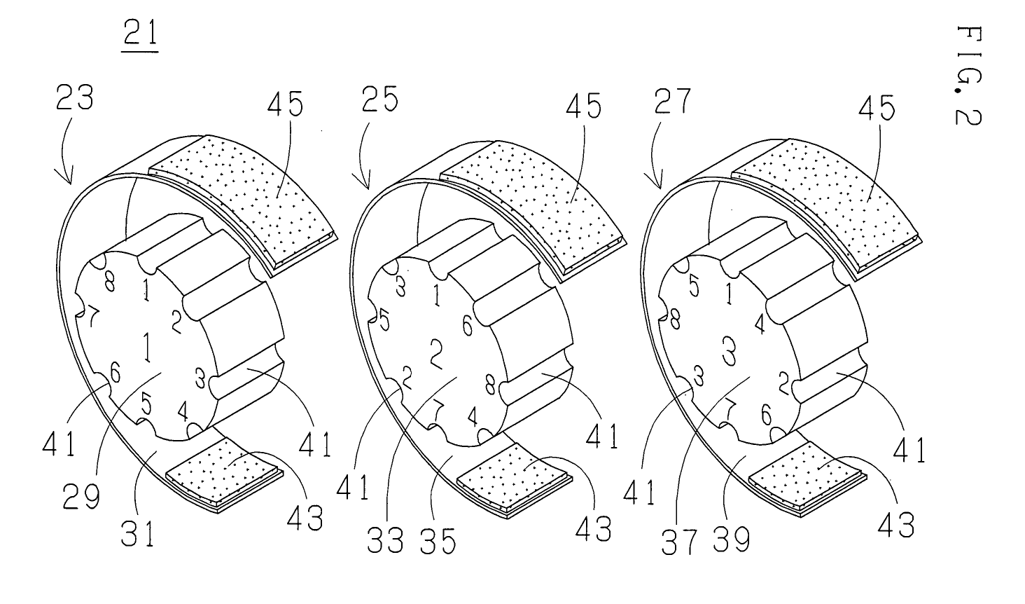

As shown in FIG. 2, the anti-crosstalk device 21 comprises three anti-crosstalk members 23, 25, 27 for telecommunication cable. The anti-crosstalk member 23 has a plastic block 29 and a fastener tape 31. Likewise, the anti-crosstalk member 25 has a plastic block 33 and a fastener tape 35, and the anti-crosstalk member 27 has a plastic block 37 and a fastener tape 39. The blocks 29, 33, 37 are identical in size and shape, and the fastener tapes 31, 35, 39 are identical in configuration.

Each of the blocks 29, 33, 37 is shaped of a cylinder with approximately 40 mm in diameter (five to eight times larger than an outer diameter of the telecommunication cable 17) and approximately 20 mm in thickness or length. Each of the blocks 29, 33, 37 is given a number or a location number indicating a location order at a center portion of a front face thereof And, each of the blocks 29, 33, 37 is provided with eight cable fit-in slots 41 properly and equally spaced apart from each other in a circumferential direction on an outer peripheral surface thereof such that one telecommunication cable 17 is fitted in each cable fit-in slot 41. Each cable fit-in slot 41 is formed so as to extend for an entire length of the thickness of each block 29, 33, 37, namely from a front face to a rear face thereof Further, each cable fit-in slot 41 is configured to have an arcuate cross section, slightly shorter or smaller than a semicircular arc. Each cable fit-in slot 41 is designed to have a diameter (diameter of an arc) of approximately 6mm, generally equal to an outer diameter (approximately 6 mm) of the telecommunication cable 17, and an opening width of 5.5 mm which is generally 90% of the outer diameter of the telecommunication cable 17.

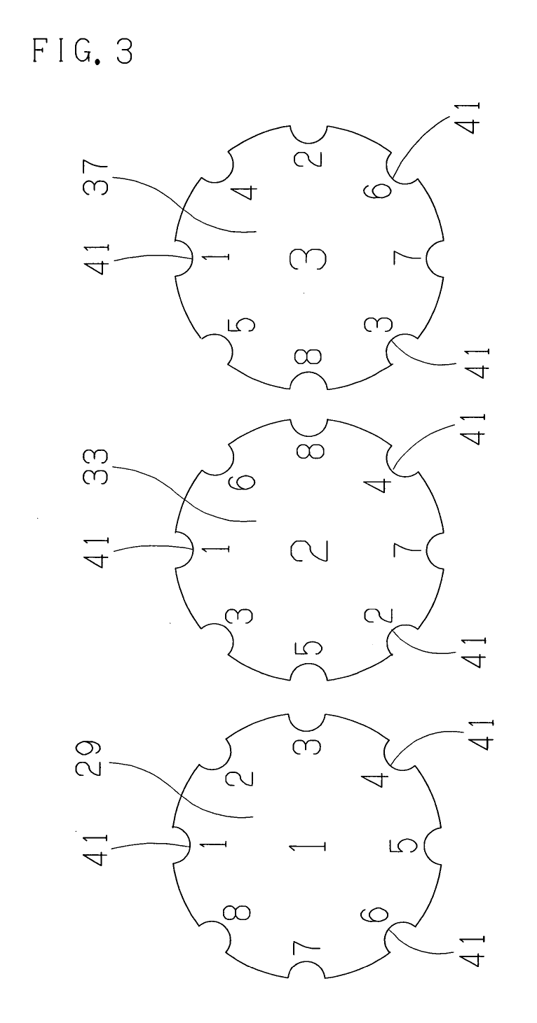

As shown in FIGS. 2 and 3, each block 29, 33, 37 is also given cable distinguishing numbers (cable distinguishing indications) 1 to 8 equally spaced apart from each other in a circumferential direction at positions corresponding to the cable fit-in slots 41 respectively on an outer peripheral portion of the front face thereof. The sequential order or sequential arrangement of the cable distinguishing numbers is different among the blocks 29, 33, 37. The block 29 is given the cable distinguishing numbers in clockwise order of 1 to 8 thereon. However, the block 33 is given the cable distinguishing numbers in clockwise order of 1, 6, 8, 4, 7, 2, 5 and 3, while the block 37 is given the cable distinguishing numbers in clockwise order of 1, 4, 2, 6, 7, 3, 8 and 5 thereon. That is, the anti-crosstalk device 21 is designed such that any or each pair of circumferentially adjacent cable distinguishing numbers of the block 29 is different in combination from any or each pair of circumferentially adjacent cable distinguishing numbers of the neighboring block 33, and such that any or each pair of circumferentially adjacent but one cable distinguishing numbers of the block 29 is different in a sequential arrangement from any or each pair of circumferentially adjacent but one cable distinguishing numbers of the adjacent block 33. And, the anti-crosstalk device 21 is designed such that any or each pair of circumferentially adjacent cable distinguishing numbers of the block 33 is different in combination from any or each pair of circumferentially adjacent cable distinguishing numbers of the neighboring block 37, and such that any or each pair of circumferentially adjacent but one cable distinguishing numbers of the block 33 is different in a sequential arrangement from any or each pair of circumferentially adjacent but one cable distinguishing numbers of the neighboring block 37. Such comparison in the cable distinguishing numbers or cable distinguishing indications is made on a basis of the blocks 29, 33, 37 disposed in predetermined state.

Each of the fastener tapes 31, 35, 39 is stretchable properly, and formed with length sufficiently longer than an outer circumferential length of each of the blocks 29, 33, 37 and with width of approximately 20 mm (generally identical to the width of each of the blocks 29, 33, 37). Each of the fastener tapes 31, 35, 39 has a sheet form male fastener 43 on one circumferential end portion thereof and a sheet form female fastener 45 on the other circumferential end portion thereof so as to attach with the one to the other circumferential end portions separably.

The anti-crosstalk members 23, 25, 27 which configure the anti-crosstalk device 21 are disposed or attached in order of location number sequentially from a side of the consolidation point 7 (refer to FIG. 1) with the front faces oriented in a direction of the consolidation point 7 (with the front faces oriented in an identical direction) on positioning spots or positions suitably selected, spaced along a length of the telecommunication cables 17. The distance between the anti-crosstalk member 23 and the anti-crosstalk member 25 is designed 8 m or less. Likewise, the distance between the anti-crosstalk member 25 and the anti-crosstalk member 27 is also designed 8m or less. And, the distance between the consolidation point 7 and the anti-crosstalk member 23 and the distance between the anti-crosstalk member 27 and the patch panel 9 is designed also 8 m or less, respectively.

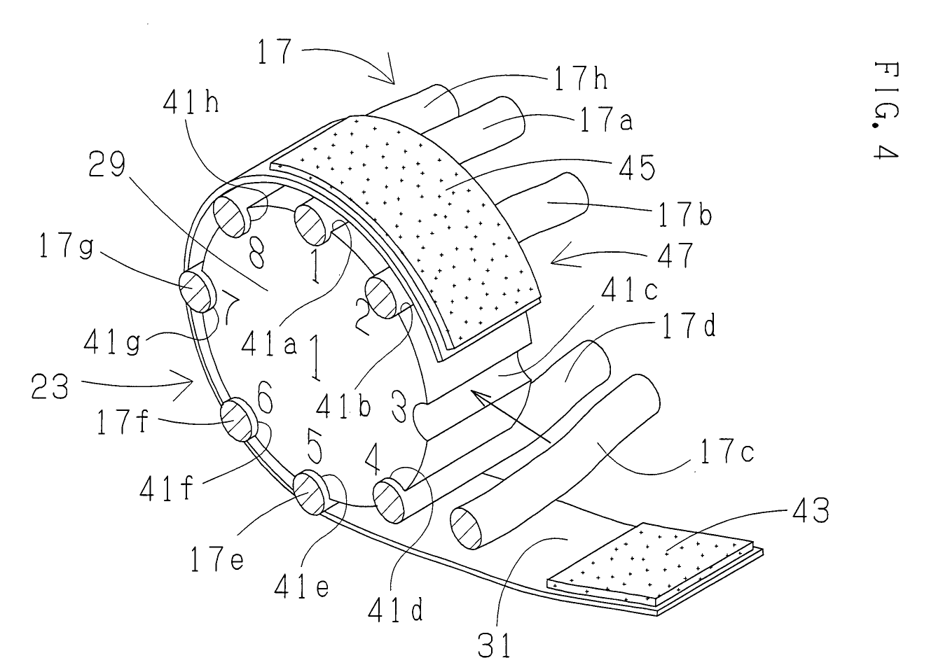

As well shown in FIG. 4, the anti-crosstalk devise 21 is attached to the same number of the telecommunication cables 17 as the cable fit-in slots 41 in a following manner. A single telecommunication cable 17a of eight telecommunication cables 17 bundled or eight telecommunication cables 17 in a bundle is fitted in a single cable fit-in slot 41a corresponding to cable distinguishing number 1 in the cable fit-in slots 41 formed in the block 29 of the anti-crosstalk member 23, and a single telecommunication cable 17b is fitted in a single cable fit-in slot 41b corresponding to cable distinguishing number 2. In this manner, the telecommunication cables 17a to 17h are fitted in respective cable fit-in slots 41a to 41h corresponding to cable distinguishing numbers 1 to 8. Then the fastener tape 31 is tightly wrapped over the telecommunication cables 17a to 17h fitted in the cable fit-in slots 41a to 41h around the block 29 and the sheet form male fastener 43 and the sheet form female fastener 45 are attached together to connect both end portions of the fastener tape 31. The telecommunication cables 17 are thereby fixedly secured in the cable fit-in slots 41. Then, the single telecommunication cable 17a is fitted in a single cable fit-in slot 41a corresponding to cable distinguishing number 1 in the cable fit-in slots 41 of the block 33 of the anti-crosstalk device 25, and the single telecommunication cable 17b is fitted in a single cable fit-in slot 41b corresponding to cable distinguishing number 2 thereof. In this manner, the telecommunication cables 17a to 17h are fitted in the cable fit-in slots 41 corresponding to cable distinguishing numbers 1 to 8 of the block 33 respectively. And, the fastener tape 35 is tightly wrapped over the telecommunication cables 17a to 17h fitted in the cable fit-in slots 41 around the block 33 and the sheet form male fastener 43 and the sheet form female fastener 45 are attached together to connect both end portions of the fastener tape 35. The telecommunication cables 17 are thereby fixedly secured in the cable fit-in slots 41 of the block 33. Further, in similar manner, telecommunication cables 17 are fitted in corresponding cable fit-in slots 41 respectively formed in the block 37 of the anti-crosstalk member 27, fixedly secured, and thereby cabling is completed. In each of the blocks 29, 33 and 37, the telecommunication cables 17 are fitted in the cable fit-in slots 41 for which identical cable distinguishing numbers are given respectively. Preferably, each of the telecommunication cables 17 is provided with cable identifying marking corresponding to the cable distinguishing number.

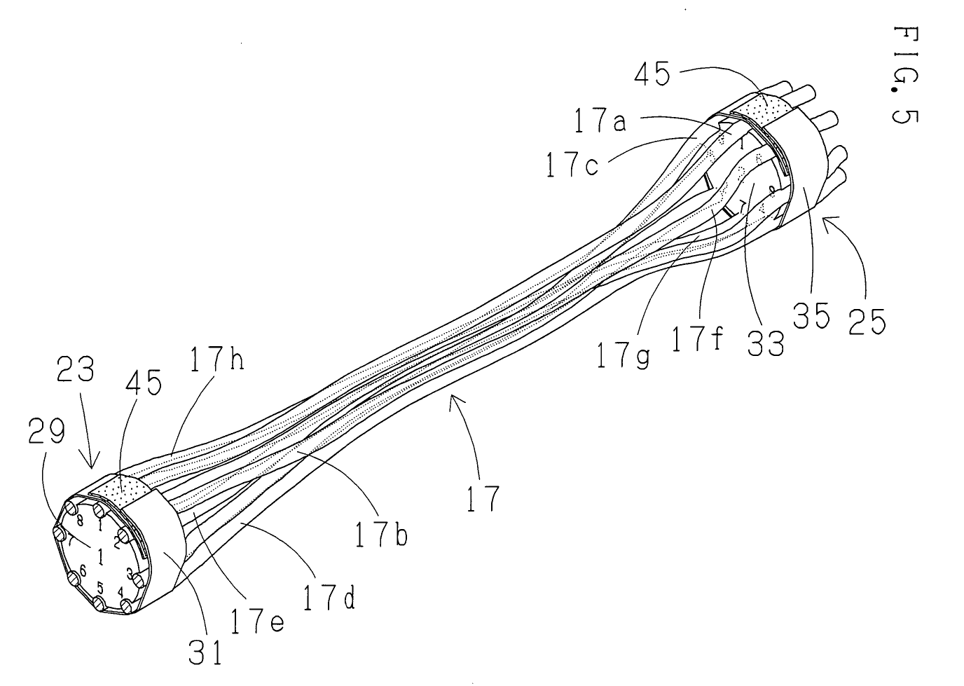

As shown in FIG. 5, in the above mentioned cabling manner, the bundled telecommunication cables 17 are split up at disposed positions or attached positions of the anti-crosstalk member 23, split up again at attached positions of the anti-crosstalk member 25, and split up yet again at attached positions of the anti-crosstalk member 27. Further, the telecommunication cables 17 are laid out such that any pair of circumferentially adjacent telecommunication cables 17 and any pair of circumferentially adjacent but one telecommunication cables 17 at disposed positions or attached positions of the anti-crosstalk member 23 are in non-parallel relation to one another (in non-parallel fashion) between the anti-crosstalk members 23 and 25, while the telecommunication cables 17 are laid out such that any pair of circumferentially adjacent telecommunication cables 17 at attached positions of the anti-crosstalk member 25 are in non-parallel relation to one another (in non-parallel fashion) between the anti-crosstalk members 25 and 27. Meanwhile, just like an anti-crosstalk device 47 for telecommunication cable of another configuration (which will be described later), the block 37 of the anti-crosstalk member 27 may be given the cable distinguishing numbers in the same sequential arrangement as the anti-crosstalk member 23.

Meanwhile, instead of the cable distinguishing numbers, cable distinguishing colors may be indicated for the cable fit-in slots 41 of the blocks 29, 33, 37. For example, red (instead of number 1), yellow (instead of number 2), green (instead of number 3), blue (instead of number 4), purple (instead of number 5), pink (instead of number 6), brown (instead of number 7) and black (instead of number 8) distinguishing stickers are affixed respectively in the positions of the blocks 29, 33, 37 where the cable distinguishing numbers are given, while sheath members for the telecommunication cables 17 are colored red, yellow, green, blue, purple, pink, brown and black respectively. Then, each of the telecommunication cables 17 is fitted in the cable fit-in slot 41 where the distinguishing sticker of the same color as cable sheath is affixed.

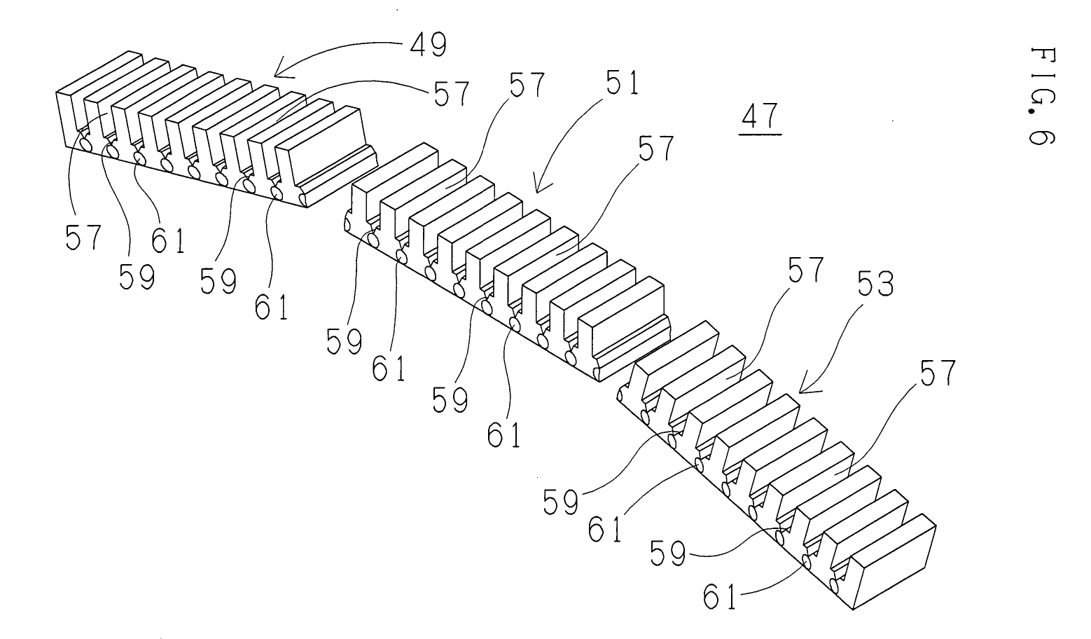

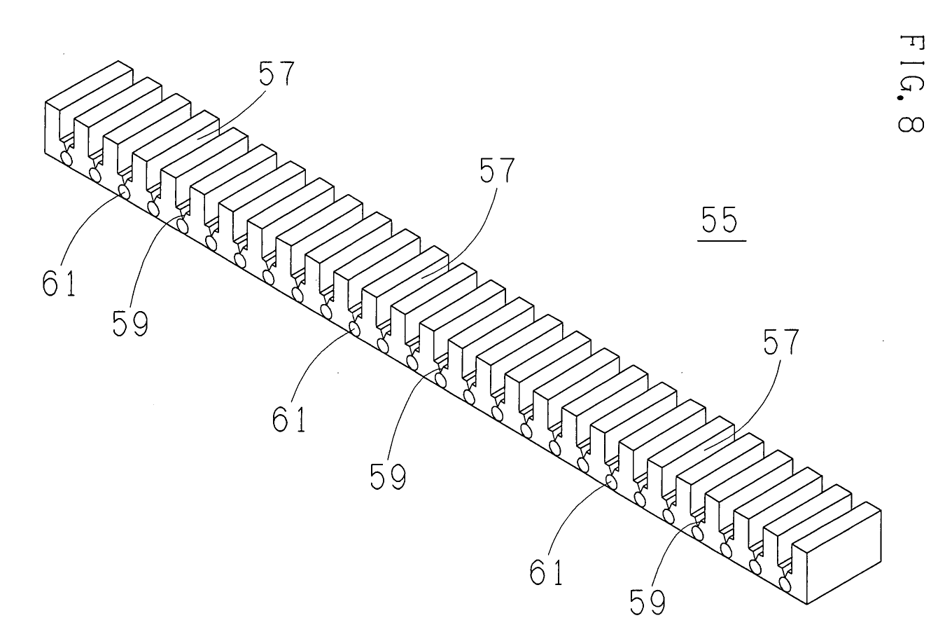

An anti-crosstalk device 47 for telecommunication cable shown in FIG. 6 has another configuration and comprises block-like anti-crosstalk members (blocks) 49, 51, 53 for telecommunication cable. The anti-crosstalk members 49, 51, 53 for telecommunication cables are shaped square log which is long in a widthwise direction and have a rectangularly corrugated cross-section, and formed by exerting a bending force to an anti-crosstalk base member 55 for forming an anti-crosstalk member (refer to FIG. 8: FIG. 8 is a perspective view of the an anti-crosstalk base member 55) to divide it into three in a widthwise direction thereof. Just like the anti-crosstalk members 23, 25, 27, the anti-crosstalk members 49, 51, 53 are disposed or attached in order from a side of the consolidation point 7 (refer to FIG. 1) with the front faces oriented in a direction of the consolidation point 7 (with the front faces oriented in an identical direction) on positioning spots or positions suitably selected, spaced along a length of the telecommunication cables 17. The distance between the anti-crosstalk member 49 and the anti-crosstalk member 51 and the distance between the anti-crosstalk member 51 and the anti-crosstalk member 53 is designed 8 m or less, respectively. And, the distance between the consolidation point 7 and the anti-crosstalk member 49 and the distance between the anti-crosstalk member 53 and the patch panel 9 is designed also 8m or less, respectively.

The anti-crosstalk base member 55 is made of plastic and has a body which is rectangularly corrugated in cross-section and sized approximately 300 mm in width, approximately 30 mm in length and approximately 20 mm in height. The anti-crosstalk base member 55 is formed with twenty-six cable fit-in slots 57 properly and equally spaced apart from one another in a widthwise direction of the anti-crosstalk base member 55. Each of the cable fit-in slots 57 in which each of the telecommunication cables 17 is fitted is shaped in rectangular cross-section, open upward. Each of the cable fit-in slots 57 is formed to run along an entire length of the anti-crosstalk base member 55, namely from an front to a rear face, and is designed with a width of approximately 5 mm, slightly smaller than an outer diameter (approximately 6 mm) of the telecommunication cable 17 and with a depth of approximately 12 mm, generally double of the outer diameter of the telecommunication cable 17. Each of the cable fit-in slots 57 includes a notch 59 of V-shape in cross-section on a bottom surface thereof along a widthwise center thereof So, the anti-crosstalk base member 55 can be cut or divided at the notch 59 of a proper position, therefore at the cable fit-in slots 57 of the proper position by exerting a bending force to the notch 59 from widthwise opposite sides thereof to construct anti-crosstalk members for telecommunication cable including suitable number of the cable fit-in slots 57 depending on a use environment. And, the anti-crosstalk base member 55, namely anti-crosstalk members 49, 51, 53 are provided with circular distinguishing recesses 61 on front faces thereof, at positions below respective cable fit-in slots 57, so as to affix distinguishing stickers (cable distinguishing indication member) in the distinguishing recesses 61. For example, distinguishing stickers of varied colors such as red, blue and yellow or distinguishing stickers printed with varied numbers such as 1, 2 and 3, varied marks or characters can be affixed on the distinguishing recesses 61 of the anti-crosstalk members 49, 51, 53 for telecommunication cable.

Preferably, the distinguishing stickers are affixed on the distinguishing recesses 61 before attaching or mounting the anti-crosstalk device 47 to the telecommunication cables 17. For example, on the anti-crosstalk member 49, red, yellow, green, blue, purple, pink, brawn and black distinguishing stickers are affixed in a sequential order from right in FIG. 6. On the anti-crosstalk member 51, green, red, black, pink, blue, brawn, yellow, and purple distinguishing stickers are affixed in a sequential order from right in FIG. 6. And, on the anti-crosstalk member 53, red, yellow, green, blue, purple, pink, brawn and black distinguishing stickers are affixed likewise on the anti-crosstalk member 49 in a sequential order from right in FIG. 6. Then, the telecommunication cables 17 are fitted in the cable fit-in slots 57 respectively. This is done by forcing the telecommunication cables 17 into the cable fit-in slots 57. As an outer diameter of the telecommunication cable 17 is sized slightly larger than a width of the cable fit-in slot 57, the telecommunication cables 17 are fixedly secured in the cable fit-in slots 57.

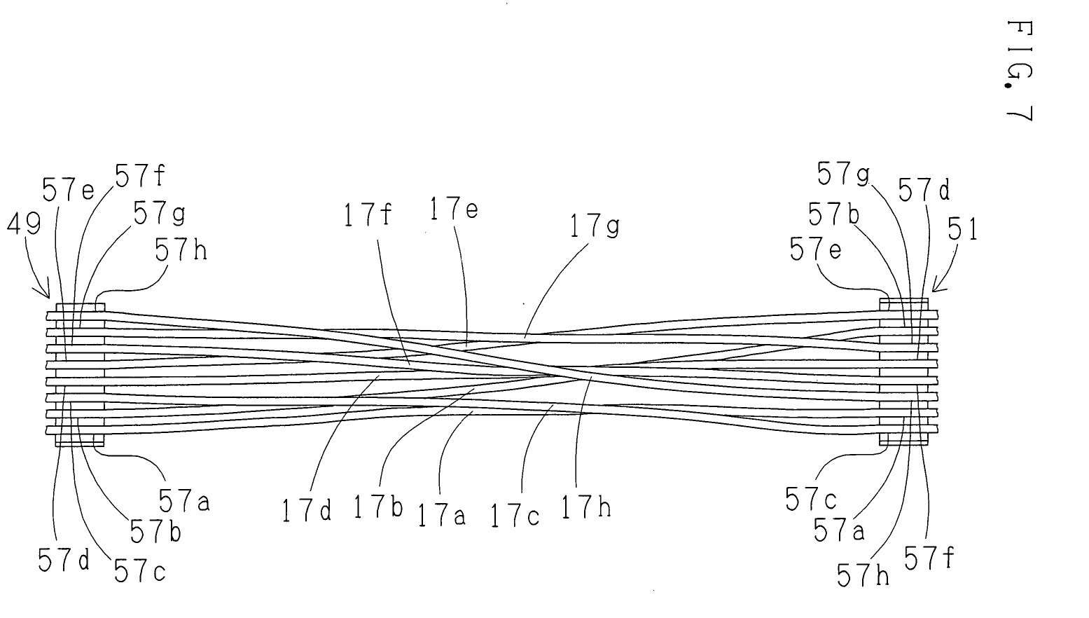

As shown in FIG. 7, the same number of the communication cables 17 as the cable fit-in slots 57 are laid out in the following manner. First, a single telecommunication cable 17a of eight telecommunication cables 17 is fitted in a single cable fit-in slot 57a corresponding to the red distinguishing sticker in the cable fit-in slots 57 provided in the anti-crosstalk member 49, a single telecommunication cable 17b is fitted in a single cable fit-in slot 57b corresponding to the yellow distinguishing sticker. Likewise, a single telecommunication cable 17c is fitted in a single cable fit-in slot 57c corresponding to the green distinguishing sticker, a single telecommunication cable 17d in a single cable fit-in slot 57d corresponding to the blue distinguishing sticker, a single telecommunication cable 17e in a single cable fit-in slot 57e corresponding to the purple distinguishing sticker, a single telecommunication cable 17f in a single cable fit-in slot 57f corresponding to the pink distinguishing sticker, a single telecommunication cable 17g in a single cable fit-in slot 57g corresponding to the brown distinguishing sticker, and a single telecommunication cable 17h in a single cable fit-in slot 57h corresponding to the black distinguishing sticker respectively. Further, the single telecommunication cable 17a is fitted in a single cable fit-in slot 57a of the cable fit-in slots 57 of the anti-crosstalk member 51 corresponding to the red distinguishing sticker, and the single telecommunication cable 17b is fitted in a single cable fit-in slot 57b corresponding to the yellow distinguishing sticker. In this manner, the telecommunication cables 17a to 17h are fitted in the cable fit-in slots 57 of the anti-crosstalk member 51 respectively. And, in a likewise manner, the telecommunication cables 17a to 17h are fixedly secured in the cable fit-in slots 57 of the anti-crosstalk member 53 respectively, and thereby cabling is completed. Each of the telecommunication cables 17 is fitted in the cable fit-in slots 57 on the anti-crosstalk members 49, 51, 53, in which distinguishing stickers of identical color are affixed. A sequential arrangement of the distinguishing stickers to be affixed in the distinguishing recesses 61 should be stated in an instruction manual or the like per the number of cable fit-in slots 57 of the anti-crosstalk members. The distinguishing stickers are arranged such that any pair of adjacent distinguishing stickers on one anti-crosstalk member is different in combination from any pair of adjacent distinguishing stickers on an anti-crosstalk member neighboring to the one anti-crosstalk member, and additionally such that any pair of adjacent but one distinguishing stickers on one anti-crosstalk member is different in a sequential arrangement from any pair of adjacent but one distinguishing stickers on an anti-crosstalk member neighboring to the one anti-crosstalk member. Such comparison in the distinguishing colors or the cable distinguishing indications is made on a basis of the anti-crosstalk members 49, 51, 53 disposed in a predetermined state. Here, sheath members for the telecommunication cables 17 may be colored variously corresponding to colors of the distinguishing stickers, respectively. And, each of the telecommunication cables 17 may be fitted in the cable fit-in slot 57 so as to match color of the sheath member of the telecommunication cable 17 with the color of the distinguishing sticker. By the way, as a matter of course, any pair of adjacent distinguishing stickers on one anti-crosstalk member may be different in a sequential arrangement from any pair of adjacent distinguishing stickers on an anti-crosstalk member neighboring to the one anti-crosstalk member.

According to the anti-crosstalk cabling method here, the telecommunication cables 17 are laid out such that any pair of adjacent telecommunication cables 17 and any pair of adjacent but one telecommunication cables 17 at disposed position or attached position of the anti-crosstalk member 49 are in non-parallel relation to one another (in non-parallel fashion) between the anti-crosstalk members 49 and 51, while the telecommunication cables 17 are laid out such that any pair of adjacent telecommunication cables 17 and any pair of adjacent but one telecommunication cables 17 at disposed position or attached position of the anti-crosstalk member 51 are in non-parallel relation to one another (in non-parallel fashion) between the anti-crosstalk members 51 and 53.

1. An anti-crosstalk cabling method for telecommunication cable to prevent crosstalk generated between a plurality of telecommunication cables laid out in a bundle, comprising;
locating each of the telecommunication cables on two or more positioning spots along an extending direction of the telecommunication cables such that at least a relative locational relationship is maintained in the telecommunication cables on said positioning spots, and
laying out the telecommunication cables so as to be located in different sequential arrangement on one positioning spot and a positioning spot neighboring to the one positioning spot.

2. An anti-crosstalk cabling method for telecommunication cable to prevent crosstalk generated between a plurality of telecommunication cables laid out in a bundle, comprising;
locating each of the telecommunication cables on two or more positioning spots along an extending direction of the telecommunication cables such that at least a relative locational relationship is maintained in the telecommunication cables on said positioning spots, and
laying out the telecommunication cables such that any pair of adjacent telecommunication cables on one positioning spot are different in a sequential arrangement from any pair of adjacent telecommunication cables on a positioning spot neighboring to the one positioning spot.

3. An anti-crosstalk cabling method for telecommunication cable to prevent crosstalk generated between a plurality of telecommunication cables laid out in a bundle, comprising;
locating each of the telecommunication cables on two or more positioning spots along an extending direction of the telecommunication cables such that at least a relative locational relationship is maintained in the telecommunication cables on said positioning spots, and
laying out the telecommunication cables such that any pair of adjacent telecommunication cables on one positioning spot are different in combination from any pair of adjacent telecommunication cables on a positioning spot neighboring to the one positioning spot.

4. An anti-crosstalk member for telecommunication cable to be adapted in the anti-crosstalk cabling method for telecommunication cable defined in claim 1 and arranged on each of the positioning spots, comprising:
a block provided with a plurality of cable fit-in slots, and
the telecommunication cables being fitted in the cable fit-in slots respectively such that at least a relative locational relationship is maintained in the telecommunication cables.

5. The anti-crosstalk member for telecommunication cable as set forth in claim 4, wherein the block is formed in cylindrical or disk shape and provided with a plurality of the cable fit-in slots circumferentially spaced apart on an outer peripheral surface thereof.

6. The anti-crosstalk member for telecommunication cable as set forth in claim 5, further comprising;
removable fastener tape wrapping around the telecommunication cables fitted in the cable fit-in slots respectively to fasten the telecommunication cables to the block.

7. The anti-crosstalk member for telecommunication cable as set forth in claim 4, wherein the block has a rectangularly corrugated cross-section and is provided with a plurality of the cable fit-in slots spaced apart in a widthwise direction thereof.

8. An anti-crosstalk device for telecommunication cable to be adapted in the anti-crosstalk cabling method for telecommunication cable defined in claim 1, comprising:
all of anti-crosstalk members for telecommunication cable to be arranged on the positioning spots respectively, each of the anti-crosstalk members having a block provided with a plurality of cable fit-in slots wherein the telecommunication cables are fitted respectively such that at least a relative locational relationship is maintained in the telecommunication cables, the block including varied cable distinguishing indications given respectively for the cable fit-in slots,
the cable distinguishing indications on one anti-crosstalk member being different in a sequential arrangement from those on an anti-crosstalk member to be arranged neighboring to the one anti-crosstalk member,
the telecommunication cables being fitted respectively in the cable fit-in slots with identical cable distinguishing indications on each of the anti-crosstalk members for telecommunication cable.

9. An anti-crosstalk device for telecommunication cable to be adapted in the anti-crosstalk cabling method for telecommunication cable defined in claim 1, comprising:
all of anti-crosstalk members for telecommunication cable to be arranged on the positioning spots respectively, each of the anti-crosstalk members having a block provided with a plurality of cable fit-in slots wherein the telecommunication cables are fitted respectively such that at least a relative locational relationship is maintained in the telecommunication cables, the block including varied cable distinguishing indications given respectively for the cable fit-in slots,
any pair of adjacent cable distinguishing indications on one anti-crosstalk member being different in a sequential arrangement from any pair of adjacent cable distinguishing indications on an anti-crosstalk member to be arranged neighboring to the one anti-crosstalk member,
the telecommunication cables being fitted respectively in the cable fit-in slots with identical cable distinguishing indications on each of the anti-crosstalk members for telecommunication cable.

10. An anti-crosstalk device for telecommunication cable to be adapted in the anti-crosstalk cabling method for telecommunication cable defined in claim 1, comprising:
all of anti-crosstalk members for telecommunication cable to be arranged on the positioning spots respectively, each of the anti-crosstalk members having a block provided with a plurality of cable fit-in slots wherein the telecommunication cables are fitted respectively such that at least a relative locational relationship is maintained in the telecommunication cables, the block including varied cable distinguishing indications given respectively for the cable fit-in slots,
any pair of adjacent cable distinguishing indications on one anti-crosstalk member being different in combination from any pair of adjacent cable distinguishing indications on an anti-crosstalk member to be arranged neighboring to the one anti-crosstalk member.

11. The anti-crosstalk device for telecommunication cable as set forth in claim 8, wherein each of the telecommunication cables has a varied cable identifying marking corresponding to each of the cable distinguishing indications, and the telecommunication cables are fitted respectively in the cable fit-in slot with identical cable distinguishing indication on each of the anti-crosstalk members so as to match the cable identifying marking of the telecommunication cable and the cable distinguishing indication of the cable fit-in slot.

12. The anti-crosstalk device for telecommunication cable as set forth in claim 11, wherein the cable distinguishing indications of the cable fit-in slots are shown by color coding and the cable identifying markings of the telecommunication cables are shown also by color coding which is represented by color of cable sheath.
